(19) United States
(12) Patent Application Publication
(10) Pub. No.: US 2026/0339588 A1
(43) Pub. Date: Oct. 29, 2026

(54) INSTRUMENT READING DISPLAY METHOD, APPARATUS, DEVICE AND COMPUTER-READABLE STORAGE MEDIUM

(71) Applicant: EHANG INTELLIGENT EQUIPMENT (GUANGZHOU) CO., LTD., Guangzhou, Guangdong (CN)

(72) Inventors: Huazhi Hu, Guangzhou, Guangdong (CN); Changwei He, Guangzhou, Guangdong (CN)

(21) Appl. No.: 18/995,926

(22) PCT Filed: Aug. 7, 2023
(86) PCT No.: PCT/CN2023/111532

§ 371 Date: Jan. 17, 2025

(30) Foreign Application Priority Data
Aug. 12, 2022 (CN) 202210968457.6

(51) Int. Cl. G06F 3/14; G06F 9/451; G09G 3/20

(52) U.S. Cl. CPC G06F 3/1407; G06F 9/451; G09G 3/2092; G09G 2320/0686

(57) ABSTRACT

An instrument reading display method, apparatus, device and computer-readable storage medium is provided. The method includes: setting digit positions required for reading display of an instrument; fixedly configuring each digit position with five text elements, in each digit position, numbers being ranked from large to small and in descending order from top to bottom; calculating a pixel height of each text element; calculating an offset coefficient for each digit position, wherein the offset coefficient for a current digit position is a number in an immediately lower digit position; calculating an overall offset pixel of the five text elements in the current digit position based on the offset coefficient and the pixel height of each text element; and controlling a transparency of the text element displayed in the digit position based on a magnitude of a distance of the overall offset pixel in the current digit position.

### TECHNICAL FIELD

The present disclosure is directed to the technical field of instrument reading display, and in particular to an instrument reading display method, apparatus, device and computer-readable storage medium.

### BACKGROUND TECHNOLOGY

Currently, automobiles, airplanes, and digital electric meters are all equipped with a variety of instrument panels that display static or dynamic data parameter information of the device, such as travel information display on automobiles, fuel gauge information display, altitude information display on airplanes, power consumption information display on digital electric meters, etc. According to the display of the data information on the instrument panel, it is convenient for users to judge the current state and usage of the device according to the reading display displayed. The display of instrument reading on the instrument panel of existing devices typically involves frequently instantiating data information into multiple UI objects and using a transparent mask technique to achieve a rolling in/out effect for gradual reading display. The continuous rolling in/out of UI objects can lead to decreased UI drawing performance and increased burden on the garbage collector, thereby reducing the overall software running performance of the control system. This can negatively impact the user experience, cause delays in data information display, and lead to incorrect user predictions or adverse consequences during device operation of the user.

### SUMMARY OF INVENTION

### Technical Issues

In view of this, the purpose of the present disclosure is to provide an instrument reading display method, apparatus, device and computer-readable storage medium to addresses the issue where the existing instrument data display necessitates frequent instantiation of multiple UI objects, resulting in decreased UI drawing performance and increased burden on the garbage collector, reduced system software running performance, affecting the timely display of data information on the instrument panel, and ultimately impacting the user's predictions and leading to adverse consequences during device operation of the user.

### Technical Solution

The technical solution adopted by the present disclosure to solve the above technical issues is as follows:

According to a first aspect of the present disclosure, an instrument reading display method is provided, applied to an interface showing a trend of reading changes, the method including following steps:
setting digit positions required for reading display of an instrument;
fixedly configuring each digit position with five text elements, in each digit position, numbers being ranked from large to small and in descending order from top to bottom;
calculating a pixel height of each text element;
calculating an offset coefficient for each digit position, wherein the offset coefficient for a current digit position is a number in an immediately lower digit position;
calculating an overall offset pixel of the five text elements in the current digit position based on the offset coefficient and the pixel height of each text element; and
controlling a transparency of the text element displayed in the digit position based on a magnitude of a distance of the overall offset pixel in the current digit position.

According to a second aspect of the present disclosure, an instrument reading display apparatus is also provided, the instrument reading display apparatus adopts steps in the above instrument reading display method, and the instrument reading display apparatus includes a digit position setting unit, a text element configuration unit, a calculation unit, an offset pixel calculation unit and a text element transparency control unit connected to each other;
the digit position setting unit is configured to set digit positions required for reading display of an instrument;
the text element configuration unit is configured to fixedly configure each digit position with five text elements, in each digit position, numbers being ranked from large to small and in descending order from top to bottom;
calculating a pixel height of each text element;
the calculation unit is configured to calculate a pixel height of each text element and determine an offset coefficient for each digit position;
the offset pixel calculation unit is configured to calculate an overall offset pixel of the five text elements in the current digit position based on the offset coefficient and the pixel height of each text element; and
the text element transparency control unit is configured to control a transparency of the text element displayed in the digit position based on a magnitude of a distance of the overall offset pixel in the current digit position, and the greater the distance, the lower the transparency of the text element display.

According to a third aspect of the present disclosure, an instrument reading display device is also provided. The device includes a memory, a processor, and a computer program stored in the memory and executable on the processor. The computer program, when executed by the processor, implements steps of the above instrument reading display method.

In addition, a computer-readable storage medium is also provided, including a processor, and a computer-readable memory, a computer program stored in the computer-readable memory. The computer program, when executed by the processor, implements steps of the above instrument reading display method.

### Beneficial Effects

The embodiments of the present disclosure provide the instrument reading display method, apparatus, device and computer-readable storage medium. The instrument reading display method sets digit positions required for reading display of an instrument; fixedly configures each digit position with five text elements, in each digit position, numbers being ranked from large to small and in descending order from top to bottom; calculates a pixel height of each text element and an offset coefficient for each digit position; calculates an overall offset pixel of the five text elements in the current digit position based on the offset coefficient and the pixel height of each text element; and controls a transparency of the text element displayed in the digit position based on a magnitude of a distance of the overall offset pixel in the current digit position. The speed of instrument reading display is relatively fast. This can effectively avoid the issue where the existing instrument data display necessitates frequent instantiation of multiple UI objects, resulting in decreased UI drawing performance and increased burden on the garbage collector, reduced system software running performance, affecting the timely display of data information on the instrument panel, and ultimately impacting the user's predictions and leading to adverse consequences during device operation of the user.

### DESCRIPTION OF THE DRAWINGS

FIG. 1 is a method flow chart of an instrument reading display method according to an embodiment of the present disclosure.

FIG. 2 is a schematic diagram of a reading display process of an instrument reading display method according to an embodiment of the present disclosure.

FIG. 3 is a method flow chart of an instrument reading display method according to another embodiment of the present disclosure.

FIG. 4 is a schematic diagram of a change in reading display transparency of an instrument reading display method according to an embodiment of the present disclosure.

FIG. 5 is a schematic diagram of a display of an instrument reading display method according to an embodiment of the present disclosure applied to a vehicle.

FIG. 6 is a structural schematic diagram of an instrument reading display apparatus according to an embodiment of the present disclosure.

### IMPLEMENTATION METHODS OF INVENTION

In order to make the technical problems, technical solutions and beneficial effects to be solved by the present disclosure clearer and more understandable, the present disclosure is further described in detail below in conjunction with the accompanying drawings and embodiments. It should be understood that the specific embodiments described herein are only used to explain the present disclosure and are not used to limit the present disclosure.

In the subsequent description, the use of suffixes such as “module”, “component” or “unit” used to represent elements is only for the purpose of facilitating the description of the present disclosure and has no specific meaning in itself. Therefore, “module”, “component” or “unit” can be used in a mixed manner.

### Embodiment 1

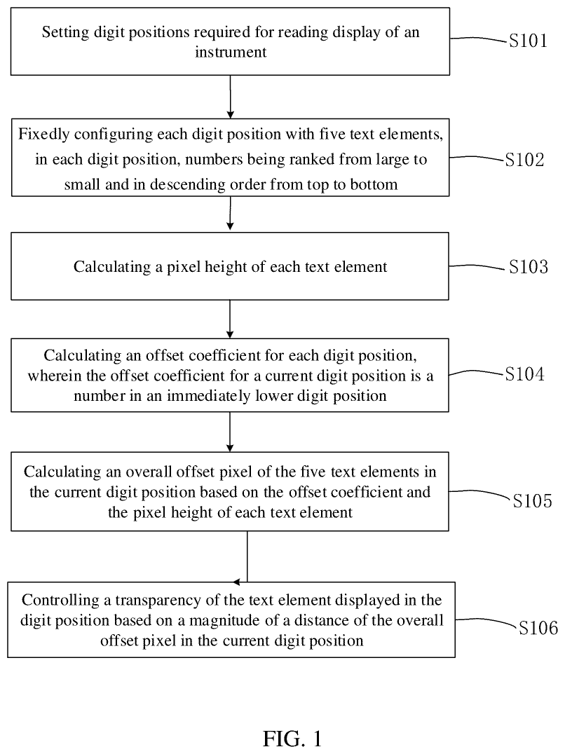

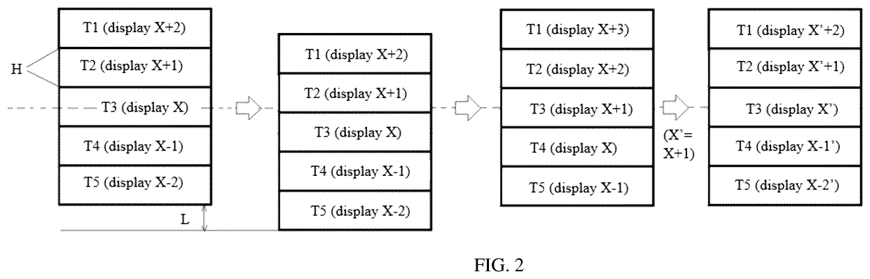

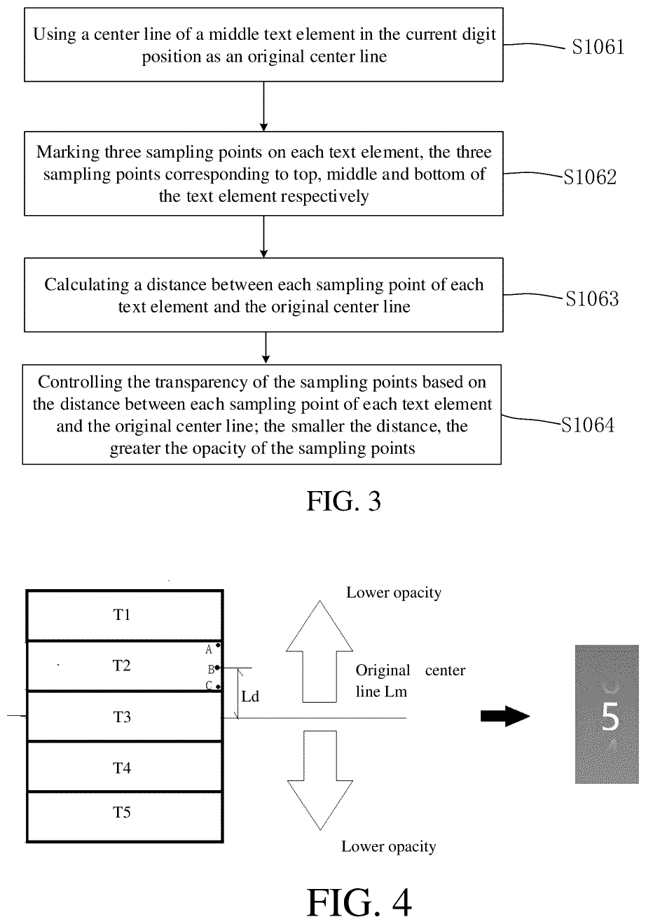

The embodiment of the present disclosure provides an instrument reading display method. The method is applied to an interface showing a trend of reading changes. For example, it can be used in display devices with instrument panels such as vehicles, airplanes, and digital electric meters. Please refer to FIGS. 1-3, the method including the following steps:
S101, setting digit positions required for reading display of an instrument.

Specifically, the digit positions required for the reading display of the instrument are set on the device with the interface showing the reading change trend, such as the instrument panel, and the digit positions include the ones place, the tens place, the hundreds place, the thousands place, and the ten thousandths place before the decimal point, and the first decimal place, the second decimal place, the third decimal place after the decimal point. The specific number of digit positions to be set can be determined according to actual needs.
S102, fixedly configuring each digit position with five text elements, in each digit position, numbers being ranked from large to small and in descending order from top to bottom.

Specifically, five text elements are fixedly configured in each digit position according to the numerical value from large to small, and in descending order from top to bottom, as shown in Table 1 below. For example, five fixed text elements are assigned to each digit position (ones, tens, hundreds, . . . ), and the five text elements are T1, T2, T3, T4, and T5, which are arranged in order from top to bottom, where T3 displays the number X in the current digit position, then T1 displays X+2, T2 displays X+1, T4 displays X−1, and T5 displays X−2. In this way, the numbers displayed in T1 to T5 gradually form a descending sequence.

TABLE 1

T1 (display X + 2)
T2 (display X + 1)
T3 (display X)
T4 (display X − 1)
T5 (display X − 2)

S103, calculating a pixel height of each text element.

Specifically, the pixel height of each text element can be measured according to the actual situation and is H.
S104, calculating an offset coefficient for each digit position, wherein the offset coefficient for a current digit position is a number in an immediately lower digit position.

Specifically, the offset coefficient for the current digit position is the number in the immediately lower digit position. For example, when calculating the overall offset pixel in the digit position which the ones place, the number in the first digit position after the decimal point is used as the offset coefficient of the ones place; when calculating the overall offset pixel in the digit position which the tens place, the number in the ones place is used as the offset coefficient of the tens place, and so on.
S105, calculating an overall offset pixel of the five text elements in the current digit position based on the offset coefficient and the pixel height of each text element.

Specifically, the number in the immediately lower digit position is used as the offset coefficient P of the current digit position;
the pixel height H of each text element in the current digit position is calculated; and
the overall offset pixel L of the five text elements in the current digit position is calculated based on the offset coefficient P and the pixel height H of each text element, that is, L=P*H.

For example, when calculating an overall offset pixel of a digit position which is a ones place, the number in the first digit position after the decimal point is used as the offset coefficient P of the ones place; the pixel height H of each text element in the digit position which is the ones place is calculated; and the overall offset pixel L of the five text elements in the current digit position which is the ones place digit is calculated based on the offset coefficient and the pixel height of each text element, that is, L=P*H.

Similarly, when calculating an overall offset pixel of a digit position which is a tens place, the number in the ones place is used as the offset coefficient P′ of the tens place; the pixel height H′ of each text element in the digit position which is the tens place is calculated; and the overall offset pixel L′ of the five text elements in the current digit position which is the tens place digit is calculated based on the offset coefficient and the pixel height of each text element, that is, L′=P′*H′.
S106, controlling a transparency of the text element displayed in the digit position based on a magnitude of a distance of the overall offset pixel in the current digit position.

Specifically, a center line of a text element arranged in a middle position is set as a reference line, the reference line corresponding to reference number 0, and sizes of the overall offset pixel and the reference number 0 are judged.

When the overall offset pixel L is less than the reference number 0, the text element in the current digit position is controlled to be offset upward as a whole.

When the overall offset pixel L is greater than the reference number 0, the text element in the current digit position is controlled to be offset downward as a whole.

When the overall offset pixel L is equal to the reference number 0, meaning that the five text elements in the current digit position are offset by a pixel distance H, and 1 is added or subtracted from originally displayed number of the text elements, as a basis for a next iteration display.

After adding or subtracting 1 to the number of the text elements originally displayed, T1-T5 form a new number sequence X′+2, X′+1, X′, X′−1, X′−2 (X′=X+1 or X′=X−1). In the next iteration, X is replaced with X′ and the process is repeated. This will achieve the purpose of reusing T1-T5.

In one embodiment, controlling the transparency of the text element displayed in the digit position based on the magnitude of the distance of the overall offset pixel in the current digit position further includes:
S1061, using a center line of a middle text element in the current digit position as an original center line;
S1062, marking three sampling points on each text element, the three sampling points corresponding to top, middle and bottom of the text element respectively;
S1063, calculating a distance between each sampling point of each text element and the original center line; and
S1064, controlling the transparency of the sampling points based on the distance between each sampling point of each text element and the original center line; the smaller the distance, the greater the opacity of the sampling points.

Specifically, as shown in FIG. 4, the five text elements T1, T2, T3, T4 and T5 are regarded as a large drawing area, and the horizontal center line of T3 is taken as the original center line. Three sampling points A, B and C (corresponding to the top, middle and bottom of the text element, respectively) are marked for each text element, and the distance between each sampling point of each text element and the original center line is calculated. The smaller the distance, the greater the opacity of the sampling point.

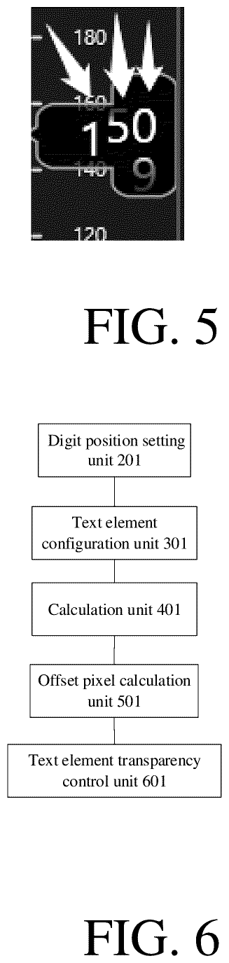

The instrument reading display method described in the embodiment of the present disclosure is applied to the interface showing the trend of reading changes, such as the mileage of a vehicle, the flight altitude of an airplane, the reading of a digital electric meter, etc. As shown in FIG. 5, when entering 150 from 149, the number 5 in the tens place follows the number 9 in the ones place and is gradually displayed from top to bottom in a slide-in manner; on the contrary, when returning from 150 to 149, the number 5 in the tens place follows the number 0 in the ones place and gradually draws upward and disappears, and the number 4 in the tens place follows the number 9 in the ones place and is gradually displayed from bottom to top in a slide-in manner. In summary, it realizes the associated display of the ones, tens, hundreds, and thousands places similar to those of a household electric meter.

The embodiments of the present disclosure provide the instrument reading display method. The instrument reading display method sets digit positions required for reading display of an instrument; fixedly configures each digit position with five text elements, in each digit position, numbers being ranked from large to small and in descending order from top to bottom; calculates a pixel height of each text element and an offset coefficient for each digit position; calculates an overall offset pixel of the five text elements in the current digit position based on the offset coefficient and the pixel height of each text element; and controls a transparency of the text element displayed in the digit position based on a magnitude of a distance of the overall offset pixel in the current digit position. The speed of instrument reading display is relatively fast. This can effectively avoid the issue where the existing instrument data display necessitates frequent instantiation of multiple UI objects, resulting in decreased UI drawing performance and increased burden on the garbage collector, reduced system software running performance, affecting the timely display of data information on the instrument panel, and ultimately impacting the user's predictions and leading to adverse consequences during device operation of the user.

### Embodiment 2

The embodiment of the present disclosure also provides an instrument reading display apparatus. The instrument reading display apparatus adopts steps in the instrument reading display method described in Embodiment 1. Please refer to FIG. 6, the instrument reading display apparatus includes a digit position setting unit 201, a text element configuration unit 301, a calculation unit 401, an offset pixel calculation unit 501 and a text element transparency control unit 601 connected to each other.

The digit position setting unit 201 is configured to set digit positions required for reading display of an instrument.

Specifically, through the digit position setting unit 201, the digit positions required for the reading display of the instrument are set on the device with the interface showing the reading change trend, such as the instrument panel, and the digit positions include the ones place, the tens place, the hundreds place, the thousands place, and the ten thousandths place before the decimal point, and the first decimal place, the second decimal place, the third decimal place after the decimal point. The specific number of digit positions to be set can be determined according to actual needs.

The text element configuration unit 301 is configured to fixedly configure each digit position with five text elements, in each digit position, numbers being ranked from large to small and in descending order from top to bottom.

Specifically, through the text element configuration unit 301, five text elements are fixedly configured in each digit position according to the numerical value from large to small, and in descending order from top to bottom. For example, five fixed text elements are assigned to each digit position (ones, tens, hundreds, . . . ), and the five text elements are T1, T2, T3, T4, and T5, which are arranged in order from top to bottom, where T3 displays the number X in the current digit position, then T1 displays X+2, T2 displays X+1, T4 displays X−1, and T5 displays X−2. In this way, the numbers displayed in T1 to T5 gradually form a descending sequence.

The calculation unit 401 is configured to calculate a pixel height of each text element and determine an offset coefficient for each digit position.

Specifically, the pixel height of each text element can be measured according to the actual situation and is H; an offset coefficient P for each digit position is calculated, wherein the offset coefficient for a current digit position is a number in an immediately lower digit position. For example, when calculating the overall offset pixel in the digit position which the ones place, the number in the first digit position after the decimal point is used as the offset coefficient of the ones place; when calculating the overall offset pixel in the digit position which the tens place, the number in the ones place is used as the offset coefficient of the tens place, and so on.

The offset pixel calculation unit 501 is configured to calculate an overall offset pixel of the five text elements in the current digit position based on the offset coefficient and the pixel height of each text element.

Specifically, the overall offset pixel L of the five text elements in the current digit position is calculated based on the offset coefficient P and the pixel height H of each text element, that is, L=P*H.

The text element transparency control unit 601 is configured to control a transparency of the text element displayed in the digit position based on a magnitude of a distance of the overall offset pixel in the current digit position, and the greater the distance, the lower the transparency of the text element display.

Specifically, a center line of a middle text element in the current digit position is used as an original center line; the three sampling points on each text element are marked, the three sampling points corresponding to top, middle and bottom of the text element respectively; a distance between each sampling point of each text element and the original center line is calculated; and the transparency of the sampling points is controlled based on the distance between each sampling point of each text element and the original center line; the smaller the distance, the greater the opacity of the sampling points.

Apart from the transparency of the displayed text elements, there will also be an offset upward or downward in the position of the displayed text elements. The upward or downward offset of the text elements specifically includes:
a center line of a text element arranged in a middle position is set as a reference line, the reference line corresponding to reference number 0, and sizes of the overall offset pixel and the reference number 0 are judged.

When the overall offset pixel L is less than the reference number 0, the text element in the current digit position is controlled to be offset upward as a whole.

When the overall offset pixel L is greater than the reference number 0, the text element in the current digit position is controlled to be offset downward as a whole.

When the overall offset pixel L is equal to the reference number 0, meaning that the five text elements in the current digit position are offset by a pixel distance H, and 1 is added or subtracted from originally displayed number of the text elements, as a basis for a next iteration display.

After adding or subtracting 1 to the number of the text elements originally displayed, T1-T5 form a new number sequence X′+2, X′+1, X′, X′−1, X′−2 (X′=X+1 or X′=X−1). In the next iteration, X is replaced with X′ and the process is repeated. This will achieve the purpose of reusing T1-T5.

The instrument reading display apparatus described in the embodiment of the present disclosure is applied to the interface showing the trend of reading changes, such as the mileage of a vehicle, the flight altitude of an airplane, the reading of a digital electric meter, etc. As shown in FIG. 5, when entering 150 from 149, the number 5 in the tens place follows the number 9 in the ones place and is gradually displayed from top to bottom in a slide-in manner; on the contrary, when returning from 150 to 149, the number 5 in the tens place follows the number 0 in the ones place and gradually draws upward and disappears, and the number 4 in the tens place follows the number 9 in the ones place and is gradually displayed from bottom to top in a slide-in manner. In summary, it realizes the associated display of the ones, tens, hundreds, and thousands places similar to those of a household electric meter.

The embodiments of the present disclosure provide the instrument reading display apparatus. The digit position setting unit 201 sets digit positions required for reading display of an instrument; the text element configuration unit 301 fixedly configures each digit position with five text elements, in each digit position, numbers being ranked from large to small and in descending order from top to bottom; the calculation unit 401 calculates a pixel height of each text element and an offset coefficient for each digit position; the offset pixel calculation unit 501 calculates an overall offset pixel of the five text elements in the current digit position based on the offset coefficient and the pixel height of each text element; and the text element transparency control unit 601 controls a transparency of the text element displayed in the digit position based on a magnitude of a distance of the overall offset pixel in the current digit position. The speed of instrument reading display is relatively fast. This can effectively avoid the issue where the existing instrument data display necessitates frequent instantiation of multiple UI objects, resulting in decreased UI drawing performance and increased burden on the garbage collector, reduced system software running performance, affecting the timely display of data information on the instrument panel, and ultimately impacting the user's predictions and leading to adverse consequences during device operation of the user.

### Embodiment 3

According to an embodiment of the present disclosure, an instrument reading display device is also provided. The device includes a memory, a processor, and a computer program stored in the memory and executable on the processor. The computer program, when executed by the processor, implements steps of the instrument reading display method of Embodiment 1.

### Embodiment 4

According to an embodiment of the present disclosure, a computer-readable storage medium is also provided. A computer program is stored thereon, and the computer program, when executed by a processor, implements steps of the instrument reading display method of Embodiment 1. The detailed steps are described in Embodiment 1, which will not be repeated here.

The memory in the embodiment can be used to store software programs and various data. The memory can mainly include a program storage area and a data storage area, wherein the program storage area can store an operating system, at least one application required for a function, etc.; the data storage area can store data created according to the use of the mobile phone, etc. In addition, the memory can include a high-speed random access memory, and can also include a non-volatile memory, such as at least one disk storage device, a flash memory device, or other volatile solid-state storage devices.

According to an example of this embodiment, all or part of the processes in the above-mentioned embodiment method can be completed by instructing the relevant hardware through a computer program, and the program can be stored in a computer-readable storage medium, such as in the embodiment of the present disclosure, the program can be stored in a storage medium of a computer system and executed by at least one processor in the computer system to implement the process of the embodiments including the above-mentioned methods. The storage medium includes but is not limited to a disk, a USB flash drive, an optical disk, a read-only storage memory (ROM), etc.

It should be noted that in this disclosure, the terms “include”, “comprise” or any other variants thereof are intended to cover non-exclusive inclusion, so that a process, method, article or device including a series of elements includes not only those elements, but also other elements not explicitly listed, or also includes elements inherent to such a process, method, article or device. In the absence of further restrictions, an element defined by the sentence “include a . . . ” does not exclude the existence of other identical elements in the process, method, article or device including the element.

The serial numbers of the above embodiments of the present disclosure are only for description and do not represent the advantages and disadvantages of the embodiments.

Through the description of the above implementation methods, those skilled in the art can clearly understand that the above implementation methods can be implemented by means of software plus the necessary general hardware platform, or by hardware, but in many cases the former is a better implementation method. Based on this understanding, the technical solution of the present disclosure in essence, that is, the part that contributes to the prior art, can be embodied in the form of a software product, which is stored in a storage medium (such as ROM/RAM, disk, CD), including several instructions for a terminal (which can be a mobile phone, computer, server, air conditioner, or network equipment, etc.) to execute the methods described in each embodiment of the present disclosure.

The above describes the embodiments of the present disclosure in conjunction with the accompanying drawings, but the present disclosure is not limited to the above specific implementation methods. The above specific implementation methods are only illustrative and not restrictive. Under the teaching of the present disclosure, ordinary skills in the art can also make many forms without departing from the scope of protection of the present disclosure and the claims, which are all within the protection of the present disclosure.

### INDUSTRIAL APPLICABILITY

The embodiments of the present disclosure provide the instrument reading display method, apparatus, device and computer-readable storage medium. The instrument reading display method sets digit positions required for reading display of an instrument; fixedly configures each digit position with five text elements, in each digit position, numbers being ranked from large to small and in descending order from top to bottom; calculates a pixel height of each text element and an offset coefficient for each digit position; calculates an overall offset pixel of the five text elements in the current digit position based on the offset coefficient and the pixel height of each text element; and controls a transparency of the text element displayed in the digit position based on a magnitude of a distance of the overall offset pixel in the current digit position. The speed of instrument reading display is relatively fast. This can effectively avoid the issue where the existing instrument data display necessitates frequent instantiation of multiple UI objects, resulting in decreased UI drawing performance and increased burden on the garbage collector, reduced system software running performance, affecting the timely display of data information on the instrument panel, and ultimately impacting the user's predictions and leading to adverse consequences during device operation of the user. Therefore, it has industrial applicability.

1. An instrument reading display method, applied to an interface showing a trend of reading changes, the method comprising following steps:
setting digit positions required for reading display of an instrument;
fixedly configuring each digit position with five text elements, in each digit position, numbers being ranked from large to small and in descending order from top to bottom;
calculating a pixel height of each text element;
calculating an offset coefficient for each digit position, wherein the offset coefficient for a current digit position is a number in an immediately lower digit position;
calculating an overall offset pixel of the five text elements in the current digit position based on the offset coefficient and the pixel height of each text element; and
controlling a transparency of the text element displayed in the digit position based on a magnitude of a distance of the overall offset pixel in the current digit position.

2. The instrument reading display method according to claim 1, wherein calculating the overall offset pixel of the five text elements in the current digit position based on the offset coefficient and the pixel height of each text element comprises:
using the number in the immediately lower digit position as the offset coefficient P of the current digit position;
calculating the pixel height H of each text element in the current digit position; and
calculating the overall offset pixel L of the five text elements in the current digit position based on the offset coefficient P and the pixel height H of each text element, that is, L=P*H.

3. The instrument reading display method according to claim 2, wherein calculating the overall offset pixel of the five text elements in the current digit position based on the offset coefficient and the pixel height of each text element comprises:
calculating an overall offset pixel of a digit position which is a ones place, specifically comprising:
using a number in a first digit position after a decimal point as the offset coefficient of the ones place;
calculating the pixel height of each text element in the digit position which is the ones place; and
calculating the overall offset pixel of the five text elements in the current digit position which is the ones place digit based on the offset coefficient and the pixel height of each text element.

4. The instrument reading display method according to claim 2, wherein controlling the transparency of the text element displayed in the digit position based on the magnitude of the distance of the overall offset pixel in the current digit position comprises:
setting a center line of a text element arranged in a middle position as a reference line, the reference line corresponding to reference number 0, and judging sizes of the overall offset pixel and the reference number 0;
when the overall offset pixel L is less than the reference number 0, controlling the text element in the current digit position to be offset upward as a whole; and
when the overall offset pixel L is greater than the reference number 0, controlling the text element in the current digit position to be offset downward as a whole.

5. The instrument reading display method according to claim 4, wherein controlling the transparency of the text element displayed in the digit position based on the magnitude of the distance of the overall offset pixel in the current digit position further comprises:
when the overall offset pixel L is equal to the reference number 0, meaning that the five text elements in the current digit position are offset by a pixel distance H, and adding or subtracting 1 from originally displayed number of the text elements, as a basis for a next iteration display.

6. The instrument reading display method according to claim 2, wherein controlling the transparency of the text element displayed in the digit position based on the magnitude of the distance of the overall offset pixel in the current digit position comprises:
using a center line of a middle text element in the current digit position as an original center line;
marking three sampling points on each text element, the three sampling points corresponding to top, middle and bottom of the text element respectively;
calculating a distance between each sampling point of each text element and the original center line; and
controlling the transparency of the sampling points based on the distance between each sampling point of each text element and the original center line; the smaller the distance, the greater the opacity of the sampling points.

7. The instrument reading display method according to claim 2, wherein setting the digit positions required for the reading display of the instrument comprises:
the digit positions required for setting the reading display of the instrument comprises:
a ones place, a tens place, a hundreds place, a thousands place, and a tens of thousands place before a decimal point, and
a first decimal place, a second decimal place, a third decimal place after the decimal point.

8. An instrument reading display apparatus, wherein the instrument reading display device adopts steps in the instrument reading display method according to claim 1, and the instrument reading display device comprises a digit position setting unit, a text element configuration unit, a calculation unit, an offset pixel calculation unit and a text element transparency control unit connected to each other;
the digit position setting unit is configured to set digit positions required for reading display of an instrument;
the text element configuration unit is configured to fixedly configure each digit position with five text elements, in each digit position, numbers being ranked from large to small and in descending order from top to bottom;
calculating a pixel height of each text element;
the calculation unit is configured to calculate a pixel height of each text element and determine an offset coefficient for each digit position;
the offset pixel calculation unit is configured to calculate an overall offset pixel of the five text elements in the current digit position based on the offset coefficient and the pixel height of each text element; and
the text element transparency control unit is configured to control a transparency of the text element displayed in the digit position based on a magnitude of a distance of the overall offset pixel in the current digit position, and the greater the distance, the lower the transparency of the text element display.

9. An instrument reading display device, comprising a memory, a processor, and a computer program stored in the memory and executable on the processor, wherein the computer program, when executed by the processor, implements steps of the instrument reading display method according to claim 1.

10. A computer-readable storage medium having a control program of an instrument reading display method stored thereon, wherein the control program of the instrument reading display method, when executed by a processor, implements steps of the instrument reading display method according to claim 1.

11. An instrument reading display device, comprising a memory, a processor, and a computer program stored in the memory and executable on the processor, wherein the computer program, when executed by the processor, implements steps of the instrument reading display method according to claim 2.

12. An instrument reading display device, comprising a memory, a processor, and a computer program stored in the memory and executable on the processor, wherein the computer program, when executed by the processor, implements steps of the instrument reading display method according to claim 3.

13. An instrument reading display device, comprising a memory, a processor, and a computer program stored in the memory and executable on the processor, wherein the computer program, when executed by the processor, implements steps of the instrument reading display method according to claim 4.

14. An instrument reading display device, comprising a memory, a processor, and a computer program stored in the memory and executable on the processor, wherein the computer program, when executed by the processor, implements steps of the instrument reading display method according to claim 5.

15. An instrument reading display device, comprising a memory, a processor, and a computer program stored in the memory and executable on the processor, wherein the computer program, when executed by the processor, implements steps of the instrument reading display method according to claim 6.

16. An instrument reading display device, comprising a memory, a processor, and a computer program stored in the memory and executable on the processor, wherein the computer program, when executed by the processor, implements steps of the instrument reading display method according to claim 7.

17. A computer-readable storage medium having a control program of an instrument reading display method stored thereon, wherein the control program of the instrument reading display method, when executed by a processor, implements steps of the instrument reading display method according to claim 2.

18. A computer-readable storage medium having a control program of an instrument reading display method stored thereon, wherein the control program of the instrument reading display method, when executed by a processor, implements steps of the instrument reading display method according to claim 3.

19. A computer-readable storage medium having a control program of an instrument reading display method stored thereon, wherein the control program of the instrument reading display method, when executed by a processor, implements steps of the instrument reading display method according to claim 4.

20. A computer-readable storage medium having a control program of an instrument reading display method stored thereon, wherein the control program of the instrument reading display method, when executed by a processor, implements steps of the instrument reading display method according to claim 5.
